(19) United States
(12) Patent Application Publication
(10) Pub. No.: US 2015/0223417 A1
(43) Pub. Date: Aug. 13, 2015

(54) VEGETABLE HAVING LOW POTASSIUM CONTENT, AND METHOD FOR CULTURING SAID VEGETABLE

(71) Applicant: Aizufujikako CO., LTD., Aizuwakamatsu-shi, Fukushima (JP)

(72) Inventor: Shigeru Matsunaga, Fukushima (JP)

(21) Appl. No.: 14/422,210

(22) PCT Filed: Nov. 1, 2013
(86) PCT No.: PCT/JP2013/079683

§ 371 Date: Feb. 18, 2015

(30) Foreign Application Priority Data
Nov. 9, 2012 (JP) 2012-247876

(51) Int. Cl. A01G 31/00; A01G 1/00; A23L 1/212

(52) U.S. Cl. CPC A01G 31/00; A23L 1/2123; A01G 1/001; A23V 2002/00

(57) ABSTRACT

An object of the present invention is to stably yield a leafy vegetable having a low potassium content even when large scale hydroponics is practiced. The cultivation is carried out by strictly controlling the concentrations of the hydroponic solutions based on the EC value throughout the entire cultivation period as well as by changing the N:P ratio between the potassium containing hydroponic solution used in the first part of the cultivation period and the subsequently used potassium-free hydroponic solution. As a result, leafy vegetables having a potassium content of about ¼ of that of the typical hydroponics leafy vegetables can be yielded with a stable quality even in large scale hydroponics.

### TECHNICAL FIELD

The present invention relates to low potassium containing leafy vegetables and methods for cultivating the same. Particularly, the present invention relates to a low potassium lettuce and a method for cultivating the same.

### BACKGROUND ART

According to the statistics released by The Japanese Society for Dialysis Therapy, the number of patients on the chronic dialysis therapy in Japan at present is over 297,000 in 2010, and is increasing by 6,000 to 10,000 every year.

Patients with renal failure have a reduced renal ability to excrete potassium and hence cannot sufficiently excrete potassium. As a result, the patients may suffer from arrhythmic, or in a serious case, hyperkalemia which causes cardiac arrest.

Under the circumstances, the patients with renal failure, depending on the stage of a chronic renal disease, need to restrict a daily potassium intake to 1,500 to 2,000 mg or less. Since potassium is contained in many food materials, a patient with a renal disease must be cautious in protein and salt intakes as well as pay attention to a potassium intake.

As potassium has long been known as one of the three major elements for plants, it is vital for the plant growth and is always contained in vegetables. For this reason, there is a demand for the supply of vegetables having a low potassium content.

Up to now, methods for cultivating low potassium spinach and other leafy vegetables have been disclosed as the methods for providing vegetables having a low potassium content (e.g., Patent Literatures 1 and 2).

According to the prior art literatures, low potassium containing vegetables were made available by cultivating the vegetables with a potassium containing hydroponic solution and subsequently cultivating with a potassium-free hydroponic solution. For example, the following Patent Literature 1 discloses a method for cultivating a low potassium spinach by specifying the periods during which the spinach is cultivated with a potassium containing hydroponic solution and a potassium-free hydroponic solution.

### CITATION LIST

### Patent Literature

Patent Literature 1: Japanese Patent Laid-Open No. 2008-61587
Patent Literature 2: Japanese Patent Laid-Open No. 2011-36226

### SUMMARY OF INVENTION

### Technical Problem

The method disclosed in the above prior art literature succeeded in cultivating a low potassium containing vegetable at a laboratory level, however, when cultivated in large scale hydroponics as in a plant factory, leafy vegetables having a low potassium content could not be stably yielded in spite of the faithfully reproduced cultivation conditions.

Further, the potassium level of leafy vegetables at the time of harvest must always be limited to a predetermined level or less in order to provide the vegetables to renal disease patients on a potassium intake restriction.

Thus, various cultivation conditions were studied to set cultivation conditions in large scale hydroponics which can achieve a stable low potassium level, cause no growth disorders and produce leafy vegetables of high quality enough to be delivered.

As a result, it has been revealed that the cultivation conditions not only during the potassium-free cultivation period but also the potassium-fed cultivation period are important. When the composition of the potassium containing hydroponic solution is changed from the composition of the conventional hydroponic solutions, leafy vegetables have been able to be produced stably without causing any growth disorders. When the hydroponic solution used during the potassium-fed cultivation period after seeding has higher ratio of nitrogen and potassium than those of the conventional solutions, low potassium leafy vegetables with a stable quality have been able to be cultivated without disorders such as changes in leaf color, and the like.

Also, when leafy vegetables are cultivated under the strict control of fertilizer conditions of hydroponic solutions throughout the cultivation periods, the vegetables having a predetermined amount of potassium content or less have been able to be obtained and fully grown leafy vegetables can be stably obtained.

### Solution to Problem

The present invention is a hydroponic solution for a low potassium leafy vegetable wherein a leafy vegetable is cultivated with a potassium containing hydroponic solution for a certain period of time and subsequently cultivated with, a potassium-free hydroponic solution instead, the potassium containing hydroponic solution having a weight ratio of nitrogen, phosphoric acid and potassium where nitrogen is at 0.5 to 7.0 and potassium is at 1.0 to 7.0 based on phosphoric acid at 1.

The present inventor carried out the cultivation under different cultivation conditions to study the conditions capable of stably providing low potassium leafy vegetables.

As a result, it has been revealed that the composition of the hydroponic solution used during the potassium-fed cultivation period after seeding is important. When the ratio of nitrogen, phosphoric acid and potassium of the potassium containing hydroponic solution is changed from that of the conventional hydroponic solutions and the cultivation is carried out using the hydroponic solution having higher weight ratios of nitrogen and potassium, low potassium leafy vegetables with a stable quality have been able to be cultivated without disorders such as changes in leaf color, and the like.

For example, when leaf lettuce is cultivated with the potassium containing hydroponic solution having the above ratio for about 5 weeks and the solution is subsequently replaced with the potassium-free hydroponic solution, the vegetable having a potassium concentration at the time of harvest of about ¼ of that of the leaf lettuce cultivated by the typical hydroponics.

Further, the hydroponic solution for a low potassium leafy vegetable of the present invention comprises the above potassium containing hydroponic solution having a weight ratio of nitrogen, phosphoric acid and potassium where nitrogen is at 1.0 to 4.0 and potassium is at 2.0 to 6.0 based on phosphoric acid at 1.

When the hydroponic solution having the above range is used, it is possible to produce leafy vegetables, which have not only a low potassium content but also a satisfactory size including the weight, height and the like, at the time of harvest.

The present invention is a method for cultivating a low potassium leafy vegetable wherein a leafy vegetable is cultivated with a potassium containing hydroponic solution for a certain period of time and subsequently cultivated with, in a potassium-free hydroponic solution instead, comprising the potassium containing hydroponic solution having a weight ratio of nitrogen, phosphoric acid and potassium where nitrogen is at 0.5 to 7.0 and potassium is at 1.0 to 7.0 based on phosphoric acid at 1.

When the hydroponic solution having the above range is used for cultivation, leafy vegetables having a low potassium content can stably be cultivated.

The method for cultivating a low potassium leafy vegetable of the present invention is a method for cultivating a low potassium leafy vegetable wherein a leafy vegetable is cultivated with a potassium containing hydroponic solution for a certain period of time and subsequently cultivated with a potassium-free hydroponic solution instead, comprising the potassium containing hydroponic solution having a weight ratio of nitrogen, phosphoric acid and potassium where nitrogen is at 1.0 to 4.0 and potassium is at 2.0 to 6.0 based on phosphoric acid at 1.

When the potassium containing hydroponic solution has a nitrogen, phosphoric acid and potassium weight ratio within this range, leafy vegetables have a satisfactory height and weight at the time of harvest and can be supplied as leafy vegetables with a stable quality.

Further, in the method for cultivating a low potassium leafy vegetable of the present invention, an EC value of the hydroponic solution is adjusted to 0.5 to 1.8 for cultivation throughout the potassium-fed cultivation period and the potassium-free cultivation period.

Leafy vegetables are typically cultivated at an EC value of about 2.2 to 3, but when cultivated under the condition of an always low EC value, more specifically, under the condition of a low concentration of the salts, which are to be fertilizers, growth disorders or changes in leaf colors, or the like, are not caused.

Furthermore, in the method for cultivating a low potassium leafy vegetable of the present invention, pH of the hydroponic solution is adjusted to 5.0 to 7.0 throughout the potassium-fed cultivation period and the potassium-free cultivation period.

When pH of the hydroponic solution is slightly acidic, all fertilizer bases have good solubility and thus the composition of the hydroponic solution becomes stable, thereby stabilizing the quality of a leafy vegetable to be yielded.

In the method for cultivating a low potassium leafy vegetable of the present invention, a fertilizer condition is controlled by continuously monitoring an EC value and pH of the hydroponic solution throughout the entire cultivation period.

It has been revealed that the cultivation performed under the constant conditions of the hydroponic solutions by constantly monitoring an EC value and pH is important to cultivate leafy vegetables with a stable quality.

In the method for cultivating a low potassium leafy vegetable of the present invention, the cultivation period with the potassium-free hydroponic solution is set to 10 to 17 days.

When a leafy vegetable is cultivated for 10 to 17 days, which varies depending on the leafy vegetable to be cultivated, it is possible to stably produce a vegetable having a low potassium content and a satisfactory size including weight, height and the like, at the time of harvest.

The leafy vegetable cultivated by the hydroponic method of the present invention has a potassium content at the time of harvest of 30% or less of that of a leafy vegetable cultivated without adjusting a potassium level.

When a leafy vegetable is cultivated with the hydroponic solution having a strictly adjusted potassium level, the leafy vegetable containing only 30% or less of potassium of the same variety of leafy vegetables cultivated without adjusting a potassium level.

When leafy vegetables having a low potassium level are obtained by the cultivation method of the present invention, renal disease patients who need to be on a potassium intake restriction can safely include these leafy vegetables in their diet.

### BRIEF DESCRIPTION OF DRAWINGS

FIG. 1 schematically shows the cultivation method.

FIG. 2 shows comparisons in potassium between the leaf lettuces cultivated by the cultivation method of the present invention and the typical cultivation method.

### DESCRIPTION OF EMBODIMENTS

The present inventors studied cultivation conditions in detail and found that the cultivation conditions during the potassium containing hydroponics period before cultivating a leafy vegetable under a low potassium condition are important, whereby the present invention was accomplished. Conventionally, the potassium-free cultivation conditions have mainly been studied to obtain a low potassium vegetable by hydroponics. However, the present inventor revealed that the composition of the hydroponic solution used during the potassium-fed cultivation period is very important to stably cultivate a leafy vegetable having a low potassium concentration. Hereinafter, the embodiments of the present invention are described in detail with reference to the drawings.

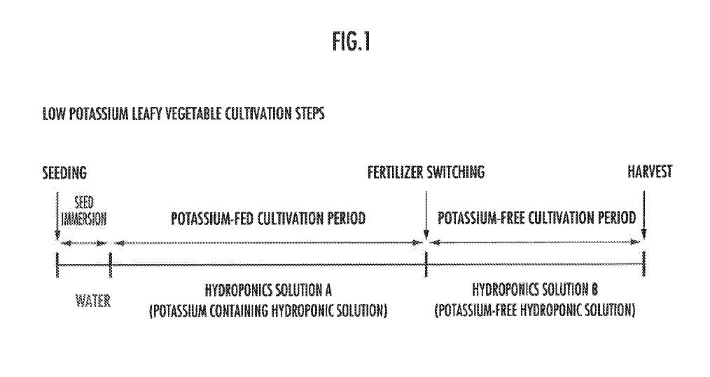

FIG. 1 schematically shows the cultivation method for a low potassium leafy vegetable.

Seeds of a leafy vegetable are immersed in water. The water used may be tap water. After immersion in water, followed by confirming the germination and rooting, the cultivation is carried out for a certain period of time using a potassium containing hydroponic solution A, and after the plant body is grown to a certain extent, it is cultivated using a potassium-free hydroponic solution B. When cultivated with the potassium-free hydroponic solution B for a certain period of time, the low potassium leafy vegetable is achieved.

For example, a leaf lettuce is cultivated with a seed immersion period of 2 to 3 days, a potassium-fed cultivation period of about 3 to 4 weeks and a potassium-free cultivation period of about 1 to 2 weeks, and subsequently harvested.

Conventionally, the potassium-free hydroponic solution used during the potassium-free cultivation period was a simple replacement of KNO₃ with NaNO₃ in the potassium containing hydroponic solution with the other composition remaining unchanged. This method managed to yield a low potassium leafy vegetable in a laboratory level as described earlier but was incapable of achieving the low potassium when shifted to large scale cultivation and caused changes in leaf color, and the like, thus failing to provide a stable yield.

In the present invention, the cultivation is carried out by changing the ratio of nitrogen, phosphoric acid and potassium of the potassium containing hydroponic solution A into a different ratio from the conventional ratio. More specifically, the potassium containing hydroponic solution used here is a composition having a weight ratio of nitrogen, phosphoric acid and potassium where nitrogen is at 0.5 to 7.0 and potassium is at 1.0 to 7.0 based on phosphoric acid at 1. Further, it is more preferable to use a hydroponic solution having such a weight ratio that nitrogen is at 1.0 to 4.0 and potassium is at 2.0 to 6.0 based on phosphoric acid at 1. Then, the cultivation is carried out using the potassium-free hydroponic solution (hydroponic solution B, composition: 3.00 mM NaNO₃, 2.00 mM Ca(NO₃)₂4H₂O, 0.50 mM NH₄H₂PO₄, 1.00 mM MgSO₄7H₂O, 26.9 μM EDTA-Fe, 4.55 μM MnCl₂4H₂O, 23.1 μM H₃BO₃, 0.38 μM ZnSO₄7H₂O, 0.16 μM CuSO₄5H₂O, 0.015 μM (NH₄)6Mo₇O₂₄4H₂O, pH of 6.5) disclosed in Patent Literatures 1 and 2, whereby a low potassium leafy vegetable with a stable quality have been able to be provided.

The hydroponic solution of the present invention used during the potassium-fed cultivation period has a weight ratio of nitrogen, phosphoric acid and potassium where nitrogen is in a range of 0.5 to 7.0 and potassium is in a range of 1.0 to 7.0 based on phosphoric acid at 1. Within these ranges, a low potassium leafy vegetable can be cultivated and yielded and more preferable the weight ratio is, nitrogen at 1.0 to 4.0 and potassium at 2.0 to 6.0. Within these ranges, a vegetable with satisfactory weight, height and appearance at the time of harvest can be cultivated. In contrast, the ratio of nitrogen used during the potassium-free cultivation period ranges from 0.9 to 1.3, based on phosphoric acid at 1.

The hydroponic solution A, which is the hydroponic solution used during the potassium containing period, contains the three major elements for plants, nitrogen, phosphoric acid and potassium in the above ratio, but it is preferable to additionally contain other elements which plants need such as magnesium, manganese, boron, and the like. The concentrations of these elements may be within the ranges contained in the hydroponic solutions used for the typical hydroponics.

In the present embodiment, the electrical conductance was measured and the EC value was maintained at 0.5 to 1.8 throughout the entire cultivation period. Thus, the cultivation can be performed under the constant solution conditions, enabling to stably supply low potassium leafy vegetables.

The pH of both hydroponic solutions A and B is adjusted to pH 4.5 to 7.0 to be slightly acidic and used. The slightly acidic pH enables all the salts in the hydroponic solutions to be dissolved and present in the ionic form, whereby the hydroponic solutions are easily absorbed by a plant.

In the hydroponics, a plant absorbs the nutrient in the hydroponic solution, which changes the composition of the hydroponic solution over time. For this reason, it is desirable that the hydroponics is carried out while the hydroponic solution is constantly watched using a monitor to adjust the composition thereof to be constant for assuring the yield of vegetables with a stable quality.

In the present embodiment, the cultivation was carried out while adjusting the hydroponic solutions by installing a monitor in the flow channel of a circular hydroponic apparatus to maintain the electrolyte and pH of the hydroponic solutions within the constant range. This cultivation method enables the conditions of hydroponic solutions to remain constant even when a large scale hydroponic system is used, thereby stably producing low potassium leafy vegetables. The hydroponics of the present invention uses a circular hydroponic apparatus but any other hydroponic apparatuses may be used as long as it is able to maintain the cultivation conditions constant.

### Example 1

Shown below are the analysis results of the inorganic elements contained in the leaf lettuce obtained by the cultivation method of the present invention and the typically cultivated leaf lettuce.

### (Method for Cultivating Leaf Lettuce)

Seeding was carried out using tap water, 3 days later a leaf lettuce was cultivated with the potassium containing hydroponic solution A for 26 days and subsequently cultivated with the potassium-free hydroponic solution B for 14 days.

The composition of the hydroponic solution A used has K and N in respective weight ratios of 4.4 and 2.3 relative to phosphoric acid, an EC value of 1.35 and pH of 6.15.

After cultivating with the hydroponic solution A for 26 days, the leaf lettuce subjected to the low potassium cultivation was cultivated with the hydroponic solution B in place of the hydroponic solution A, while the leaf lettuce subjected to the typical cultivation was cultivated by keep using the hydroponic solution A.

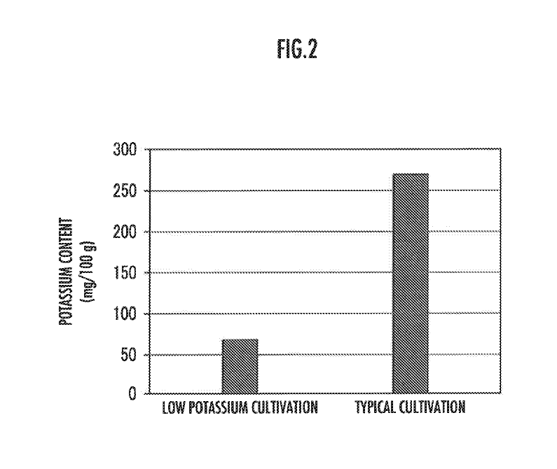

FIG. 2 shows the potassium concentration comparison between the leaf lettuce obtained by the cultivation method of the present invention and the typical leaf lettuce, and Table 1 shows the inorganic element contents.

TABLE 1

| | Low potassium lettuce | Typically cultivated lettuce |
|---|---|---|
| | (mg/100 g) | (mg/100 g) |
| Potassium | 69 | 270 |
| Sodium | 100 | 13 |
| Calcium | 29 | 56 |
| Magnesium | 22 | 22 |

As shown in FIG. 2 and Table 1, the potassium content of the low potassium leaf lettuce of the present invention is about ¼ when compared with the typical hydroponics leaf lettuce. According to the method of the present invention, leafy vegetables having a potassium content of 30% or less of the typical hydroponics leafy vegetables can be stably yielded.

Loose leaf lettuce usually has a high potassium content, and according to the food composition database provided by the Ministry of Education, Culture, Sports, Science and Technology in Japan (http://fooddb.jp/), a potassium content is 490 mg in leaf lettuce and 410 mg in red leaf lettuce per 100 g. As shown in Table 1, the cultivation using the hydroponic solution A alone throughout the entire period can reduce a potassium value to as low as 270 mg when compared with the leaf lettuce yielded by soil cultivation or the typical hydroponics, and the subsequent cultivation using the potassium-free hydroponic solution B can even reduce a potassium content to 70 mg or less.

As shown in Table 1, the low potassium leaf lettuce has a higher sodium content when compared with the typically cultivated leaf lettuce. However, the value 100 mg is a salt equivalent of only 0.3 g and the salt intake restriction is easier to practice, and hence the effect rendered by potassium reduction is more effective to improve the diet for a renal disease patient than the sodium ion increase.

### Example 2

Next, a leaf lettuce was cultivated by changing the nitrogen and potassium concentration ratio, and the like, of the hydroponic solution A, i.e., the hydroponic solution used during the potassium-fed cultivation period, to evaluate whether the leaf lettuce satisfies the delivery criteria based on the potassium content, and weight, height and also appearance at the time of harvest. The cultivation was carried out in the same mariner as in the leaf lettuce cultivation method of Example 1 such as the cultivation period, and the like, with the only exception that the composition of hydroponic solution A was different.

TABLE 2

| Sam- | | | | | K Content | Weight | Height | Good/ |
|---|---|---|---|---|---|---|---|---|
| ple | K | N | EC | pH | (mg/100 g) | (g) | (mm) | Poor |
| 1 | 1.0 | 2.0 | 1.52 | 6.25 | 52 | 54.0 | 201.6 | X |
| 2 | 2.0 | 2.0 | 1.57 | 6.18 | 59 | 83.1 | 188.3 | ◯ |
| 3 | 2.2 | 0.6 | 1.63 | 6.06 | 36 | 83.3 | 171.6 | X |
| 4 | 4.4 | 0.5 | 1.61 | 6.66 | 52 | 94.6 | 189.0 | X |
| 5 | 4.4 | 1.0 | 1.56 | 5.90 | 45 | 89.1 | 224.2 | ◯ |
| 6 | 4.4 | 2.3 | 1.51 | 6.15 | 51 | 84.9 | 196.1 | ◯ |
| 7 | 4.4 | 2.3 | 1.51 | 5.00 | 51 | 85.2 | 230.0 | ◯ |
| 8 | 4.4 | 2.3 | 1.30 | 6.15 | 66 | 86.9 | 233.0 | ◯ |
| 9 | 4.4 | 3.0 | 1.55 | 5.74 | 55 | 88.8 | 197.5 | ◯ |
| 10 | 4.4 | 4.0 | 1.55 | 5.89 | 56 | 91.5 | 211.6 | ◯ |
| 11 | 4.4 | 5.0 | 1.56 | 6.26 | 68 | 66.6 | 197.5 | X |
| 12 | 4.4 | 6.0 | 1.70 | 6.44 | 45 | 82.8 | 205.0 | X |
| 13 | 4.4 | 7.0 | 1.72 | 6.44 | 42 | 83.6 | 185.0 | X |
| 14 | 6.0 | 2.3 | 1.68 | 6.13 | 44 | 76.3 | 196.6 | ◯ |
| 15 | 7.0 | 2.0 | 1.77 | 6.51 | 58 | 77.3 | 190.0 | X |

In the Table, K and N show the respective weight ratios of potassium and nitrogen based on phosphoric acid at 1. EC and pH show the EC value and pH of each hydroponic solution.

K Content shows an amount of potassium in the leaf lettuce weight of 100 g in the unit of mg. Weight and Height shown are those at the time of harvest. Good/Poor are the comprehensive evaluation of productivity based on the weight, height, yellowing leaf and the like, at the time of harvest. Those having a weight of 75 g or less or a height of 185 mm or less are considered as poor. Also, in this cultivation experiment, Samples 4, 12 and 15 had the color changes in the leaf tips causing bad appearance, based on which these Samples are thus considered as poor.

As evident in Table 2, the amounts of potassium in 100 g of the leaf lettuces are 70 mg or less when any of the hydroponic solutions were used. In the case of a renal disease dialysis patient who needs on a dietary restriction, the daily potassium intake to be achieved is said to be about 1500 to 2000 mg. When an amount of potassium per 100 g is 70 mg or less, the patient can be on a diet with a sufficiently reduced potassium intake even though potassium is contained in other food materials.

The above results reveal that in a potassium containing hydroponic solution having a weight ratio of nitrogen, phosphoric acid and potassium where nitrogen is at 0.5 to 7.0 and potassium is at 1.0 to 7.0 based on phosphoric acid at 1, a leafy vegetable having a sufficiently low potassium value can be cultivated.

Further, as shown in Table 2, when a potassium weight ratio in the hydroponic solution A is as low as 1.0 (Sample 1) when phosphoric acid is 1, the weight at the time of harvest is low, whereas when a potassium weight ratio is as high as 7.0 (Sample 15), the weight and height at the time of harvest meet the criteria but the yellowing of leaf tips are often found which was thus considered as poor appearance. All the leaf lettuces had a potassium content far below the criterion value at the time of harvest and hence are acceptable, however, from the viewpoint of productivity, it is preferable that a potassium weight ratio is 2.0 to 6.0 when phosphoric acid is 1.

With the nitrogen content of the hydroponic solutions, the lettuces having a low nitrogen content (Samples 3 and 4) had an unsatisfactory height at the time of harvest (Sample 3) or yellowing at the leaf tips (Sample 4), thereby being considered as poor appearance. With the lettuces having a high nitrogen content (Samples 11 to 13), an unsatisfactory weight (Sample 11) at the time of harvest, an unsatisfactory height (Sample 13) at the time of harvest and yellowing at the leaf tips (Sample 12) were found, thereby being considered as poor.

Further, for the pH, an acid region of below pH 5.0 and an alkaline region exceeding 7.0 resulted in an unsatisfactory weight, adversely affecting the growth.

Furthermore, for an EC value of below 0.5, the growth is poor and took an extremely long time, whereas an EC value exceeding 1.8 resulted in a shortage of weight.

Consequently, all the leaf lettuces had a potassium content far below the criterion value at the time of harvest and hence are acceptable, however, from the viewpoint of productivity, it is preferable that a nitrogen weight ratio be 1.0 to 4.0 when phosphoric acid is 1.

### Example 3

Next, a leaf lettuce was cultivated with a different cultivation period for the potassium-free hydroponic solution (hydroponic solution B) and the potassium content was measured. Using the hydroponic solution A used in Example 1, the cultivation was carried out with the cultivation period, during which the potassium-free hydroponic solution, i.e., the hydroponic solution B, is used, changed to 0 to 17 days, and the potassium content was measured. Table 3 shows the results.

TABLE 3

| Hydroponics solution B | K Content |
|---|---|
| cultivation period (days) | (mg/100 g) |
| 0 | 380 |
| 3 | 210 |
| 5 | 160 |
| 8 | 96 |
| 10 | 63 |
| 14 | 51 |
| 17 | 42 |

As shown in Table 3, the longer the potassium-free cultivation period becomes, the less the K content per 100 g becomes. However, when the cultivation is continued under the potassium-free condition over a long period of time, the weight per stump is decreased. The lettuces cultivated for 17 days without potassium had a potassium value of as low as 42 mg but the weight of a stump is reduced to about ½. Thus, it is desirable to harvest after 10 to 14 days of the potassium-free hydroponics period, which is well balanced between the potassium content and the yield amount.

### Example 4

Subsequently, spinach, Japanese mustard spinach, Korean lettuce and endive were tested to confirm whether or not they can be cultivated as low potassium vegetables by the same hydroponic method as in the leaf lettuce.

Seeding was carried out using tap water, 3 days later the leaf lettuce was cultivated with the potassium containing hydroponic solution A for 26 days and subsequently cultivated with the potassium-free hydroponic solution B for 14 days.

The composition of hydroponic solution A used has K and N in respective weight ratios of 4.4 and 2.3 relative to phosphoric acid, an EC value of 1.51 and pH of 6.15.

After cultivating with the hydroponic solution A for 26 days, the leaf lettuce subjected to the low potassium cultivation was cultivated with the hydroponic solution B in place of the hydroponic solution A, while the leaf lettuce subjected to the typical cultivation was cultivated by keep using the hydroponic solution A.

Table 4 shows the results.

TABLE 4

| | Potassium content (mg/100 g) | | |
|---|---|---|---|
| | | Low potassium | Amount of |
| Leafy vegetables | Typical cultivation | cultivation | potassium (%) |
| Spinach | 430 | 290 | 40 |
| Japanese mustard | 310 | 130 | 42 |
| spinach | | | |
| Korean lettuce | 340 | 75 | 22 |
| Endive | 400 | 230 | 57 |

Amount of potassium (%) is a value obtained by dividing an amount of potassium in a vegetable produced by the low potassium cultivation provided with the potassium-free cultivation period by a potassium content of a vegetable cultivated by the typical cultivation using the potassium containing hydroponic solution throughout the entire cultivation period.

All spinach, Japanese mustard spinach, Korean lettuce and endive grew without problems even when the potassium-free hydroponics period was practiced. Particularly, Korean lettuce shows an extremely low potassium content of 22% when compared with those typically cultivated. Each of these leafy vegetables requires a different period, and the like, until the harvest and thus the cultivation cannot be carried out under the indiscriminately same conditions, but when each vegetable was optimized within the cultivation condition ranges of the present invention, the cultivation of leafy vegetables having a sufficiently low potassium content becomes achievable.

### Example 5

The present inventor found that the low potassium leaf lettuce is also advantageous in the light of taste.

The taste test was carried out by the double blind test method in which neither subjects nor examiners knew which of the samples was the low potassium leaf lettuce. 16 male and female subjects of the age groups shown in Table 5 tasted a low potassium leaf lettuce produced by the cultivation method in the same manner as in the cultivation of Example 1 and a typically cultivated leaf lettuce and selected the one with sweetness and good crispness. A comment entry space was provided for the description of differences in the taste.

TABLE 5

| | Low potassium | Typically |
|---|---|---|
| | lettuce | cultivated lettuce |
| Sweetness | 15 | 1 |
| Crispness | 10 | 6 |

TABLE 6

| | | |
|---|---|---|
| 30s | 40s | 50s |

| Male | Female | Male | Female | Male | Female |
|---|---|---|---|---|---|
| 3 | 4 | 5 | 2 | 1 | 1 |

As a result, there were significantly more subjects who sensed sweetness and also crispness in the low potassium leaf lettuce than the typically cultivated leaf lettuce. Also, there were three subjects who wrote in the comment entry space that the low potassium leaf lettuce had better aftertaste or freshness, suggesting that the low potassium leaf lettuce is also better in taste than the typical hydroponics products.

Further, since the low potassium leaf lettuce has characteristics in taste such as sweetness, good aftertaste, and the like, it is considered to be widely accepted also by the general consumer in addition to the renal disease patients on a potassium intake restriction.

Up to now, as potassium is water-soluble, vegetables were boiled, soaked in water, or the like, before consumed to reduce potassium contained in food products. For this reason, it was difficult to eat leafy vegetables uncooked such as salad, or the like, without exceeding a daily potassium intake.

The low potassium leaf lettuce of the present invention, when compared with the typical hydroponic leaf lettuce, has a potassium content of about ¼. It is extremely important for a patient with a chronic renal disease on a restricted daily potassium intake of 1,500 to 2,000 mg or less to have vegetables with a potassium content of about ¼ of the typical vegetables to practice such a dietary restriction.

As described above, the present invention is applicable to, not only leaf lettuces, but also a wide variety of leafy vegetables. Further, when the hydroponic method of the present invention is employed, vegetables having an amount of potassium reduced to about 20% of that of the typically cultivated vegetables are made available. In conclusion, the present invention can provide the low potassium vegetables safely consumed even by a renal disease patient who has to be on a strict dietary restriction.

1-2. (canceled)

3. A method for cultivating a low potassium leafy vegetable wherein a leafy vegetable is cultivated with a potassium containing hydroponic solution for a certain period of time and subsequently cultivated with a potassium-free hydroponic solution instead,
wherein the potassium containing hydroponic solution has a weight ratio of nitrogen, phosphoric acid and potassium where nitrogen is at 0.5 to 7.0 and potassium is at 1.0 to 7.0 based on phosphoric acid at 1, and
wherein an EC value of the hydroponic solution is adjusted to 0.5 to 1.8 for cultivation throughout the potassium-fed cultivation period and the potassium-free cultivation period.

4. The method for cultivating a low potassium leafy vegetable according to claim 3,
wherein the potassium containing hydroponic solution has a weight ratio of nitrogen, phosphoric acid and potassium where nitrogen is at 1.0 to 4.0 and potassium is at 2.0 to 6.0 based on phosphoric acid at 1.

5. (canceled)

6. The method for cultivating a low potassium leafy vegetable according to claim 3,
wherein pH of the hydroponic solution is adjusted to 5.0 to 7.0 throughout the potassium-fed cultivation period and the potassium-free cultivation period.

7. The method for cultivating a low potassium leafy vegetable according to claim 6,
wherein a fertilizer condition is controlled for cultivation by continuously monitoring the EC value and pH of the hydroponic solution throughout the entire cultivation period.

8. The method for cultivating a low potassium leafy vegetable according to claim 3,
wherein the cultivation period with the potassium-free hydroponic solution is set to 10 to 17 days.

9. A low potassium leaf lettuce of leafy vegetable cultivated by a hydroponic method according to claim 3,
wherein the low potassium leaf lettuce has a potassium content at a time of harvest of 70 mg/100 g or less.
